(19) United States
(12) Patent Application Publication
(10) Pub. No.: US 2014/0073180 A1
(43) Pub. Date: Mar. 13, 2014

(54) CORROSION RESISTANT ELECTRICAL ASSEMBLY WITH CONNECTORS AND MULTI-PORT JUNCTION BLOCK

(71) Applicants: Steven J. Knight, Mission Hill, SD (US); Jason E. Anderson, Yankton, SD (US)

(72) Inventors: Steven J. Knight, Mission Hill, SD (US); Jason E. Anderson, Yankton, SD (US)

(21) Appl. No.: 13/608,934

(22) Filed: Sep. 10, 2012

(51) Int. Cl. H01R 13/52

(52) U.S. Cl. CPC H01R 13/5221
USPC 439/588; 439/649

(57) ABSTRACT

A corrosion resistant electrical system for communicating ‘caking between a power source and multiple electric devices on a truck box or trailer. A hard plastic junction block with a male connector for power input communicates internally with two or more female connectors for power output, allowing multiple electric motors or other devices to receive electricity from a single power cable. The assembly includes cables with female or male connectors at the ends, the connectors having corresponding projecting portions and passageways, and U-shaped flanges and spaces, that fit together. The space between the projecting portions and the passageways are sealed by a resilient gasket around the projecting portion, and the U-shaped flanges and projecting portions contain aligned apertures to receive a lock pin to secure the mated connectors together.

### FIELD OF THE INVENTION

The field of the invention relates to electrical connectors and junction blocks, and more particularly to a system of sealed, corrosion resistant and securely mated electrical cables, connectors and junction blocks.

### BACKGROUND OF THE INVENTION

In recent years the number of electric motors and electric devices associated with truck boxes and trailers has increased. All of the motors and other electric devices on a truck box or trailer typically require DC current from a single battery located on the truck cab. Electric cables need to connect each of the motors and devices to the battery or other power source. Making multiple battery-to-motor connections individually requires the use of multiple, lengthy and expensive cables that tend to clog the wiring channels, if multiple cables can even fit in those channels.

In order to reduce the expense and burden of using multiple, lengthy cables between the battery and the electric motors or other devices, junction boxes have been employed. Such boxes used a single cable to create a power source at a more convenient location on the truck box or trailer devices in need of electricity. This reduced the expense of and channel clogging caused by multiple cables traversing the same path, but created other problems.

For example, connecting cables to the junction box is laborious as heavy cables need to be cut to length, stripped of insulation on each conductor and attached to terminals on the box. At the end of the cable attached to an electric motor or device, each conductor needed to be stripped and crimped or soldered onto heavy duty ring terminals. These operations require special tools and extra installation labor, and can be time consuming and expensive to perform.

Electric motors and devices are often added to a truck box or trailer after it is manufactured and delivered, i.e., as a retrofit product or accessory. This increases the difficulty of wiring as the original arrangement may not accommodate the addition of more cables and connections to the junction box. Moreover, retrofit additions of motors or other devices requires that modifications be made by persons (such as equipment operators) in the field who may not be experienced with electrical connectors or wiring, and under challenging circumstances, uncomfortable weather or difficult working conditions.

In addition, in use, truck boxes and trailers experience extreme ambient temperatures combined with moisture, constant high winds, direct sunlight, road salt, and de-icing or other chemicals. As a result, junction boxes, and wiring, ring terminals and other connections on the truck boxes or trailers are subject to corrosion and relatively high failure rates over time. Hence, conventional wiring arrangements on truck boxes and trailers present a number of problems.

### SUMMARY OF THE INVENTION

It is an object of the invention to provide a corrosion resistant wiring system for truck boxes and trailers.

It is another object of the invention to provide a system of easy to connect cables that will stay securely connected.

It is yet another object of he invention to provide a multi-port junction block for the trailer environment.

It is a further object of the invention to provide a wiring system that can easily accommodate additional electric motors or devices on the truck box or trailer,

It is yet a further object of the invention to provide a wiring system with reduced need for multiple and expensive cables traversing the same channels.

It is yet an additional object of the invention to provide a wiring system accomplishing a combination of two or more of the objects previously mentioned.

Other systems, methods, features and advantages of the invention will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

In order to better appreciate how the advantages and objects of the inventions are obtained, a more particular description of the system, arrangement, connectors and junction block briefly described above will be rendered by reference to specific embodiments thereof and illustrated in the accompanying drawings. It should be noted that the components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

FIG. 1 is a perspective view of a male electric cable connector and cable with terminal rings according to an embodiment of the present invention.

FIG. 2 is a perspective view of a female electric cable connector and cable with male trailer connector according to an embodiment of the present invention.

FIG. 3 is a perspective view of a male cable connector mated with female cable connector, secured together with a lock pin according to an embodiment of the present invention.

FIG. 4 is a perspective view of a multi-port junction block according to an embodiment of the present invention.

FIG. 5 is a second perspective view of a multi-port junction block according to an embodiment of the present invention.

FIG. 6 is a perspective view of a male plug according to an embodiment e of the present invention.

FIG. 7 is a perspective view of a system of electrical male cable connectors, an electrical female cable connector, a male plug, and a junction block and lock pins according to an embodiment of the present invention;

FIG. 8 is a perspective view of a truck cab and trailer including a system of a battery, cables, cable connectors and a junction block according to an embodiment of the present invention;

### DETAILED DESCRIPTION OF THE PREFERRED EMBODIMENTS

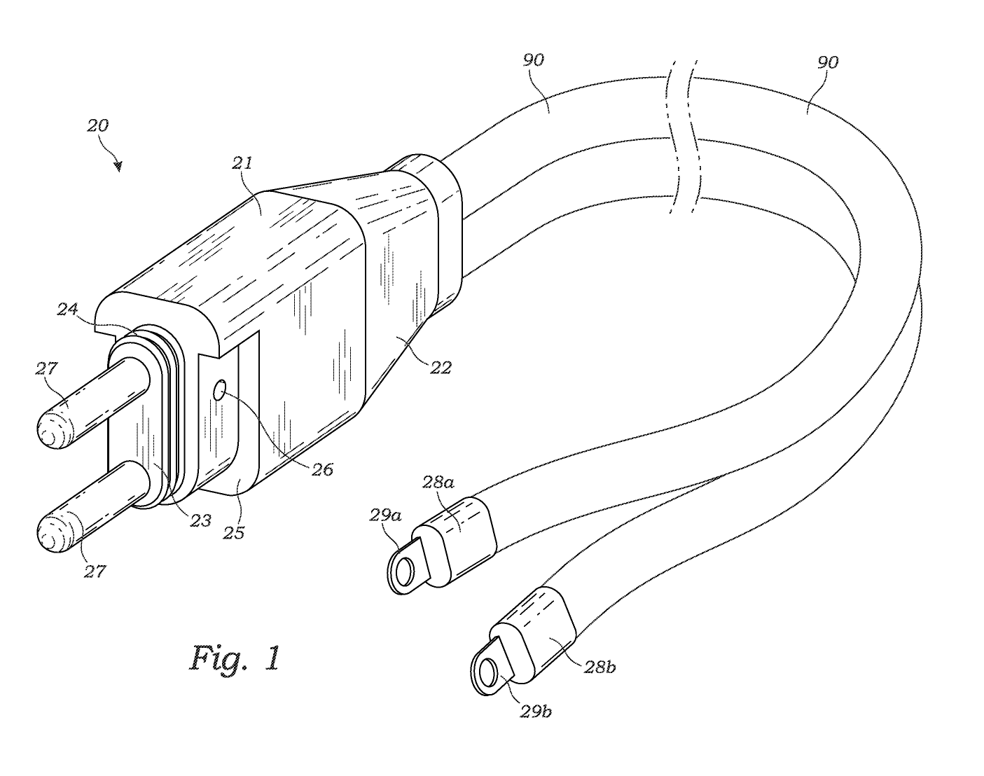

Referring to FIG. 1, an electrical male cable connector 20 is shown. The mate cable connector 20 is molded with a weather resistant and electrically insulating (or electrically non-conducting) material such as hard plastic, preferably polyvinylchloride (PVC) rubber. The male cable connector 20 has a generally rectangular portion 21 in the center being about 1.4 inches from front to back, about 1.4 inches from top to bottom, and about 0.8 inches thick, a rear portion 22 tapering toward the rear, and a projection portion 23 that is generally oblong and about 0.3 inches from front to back, 1 inch top to bottom, and about 0.3 inches thick. The general shape and dimension of the male cable connector 20 is adapted to fit into and through the wiring channels of truck boxes or trailers.

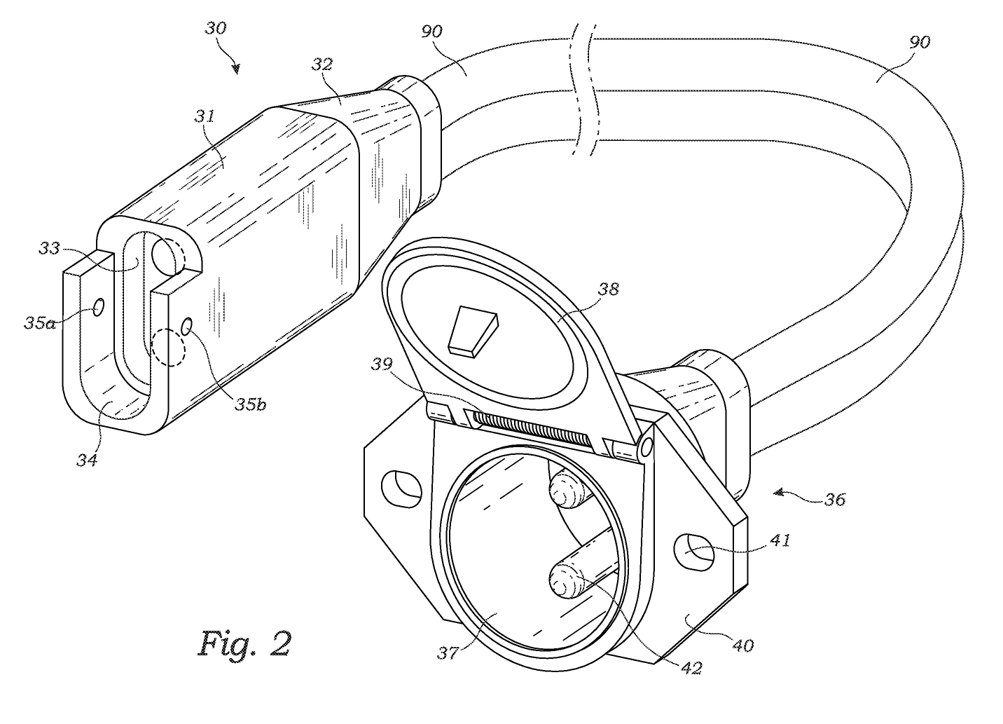

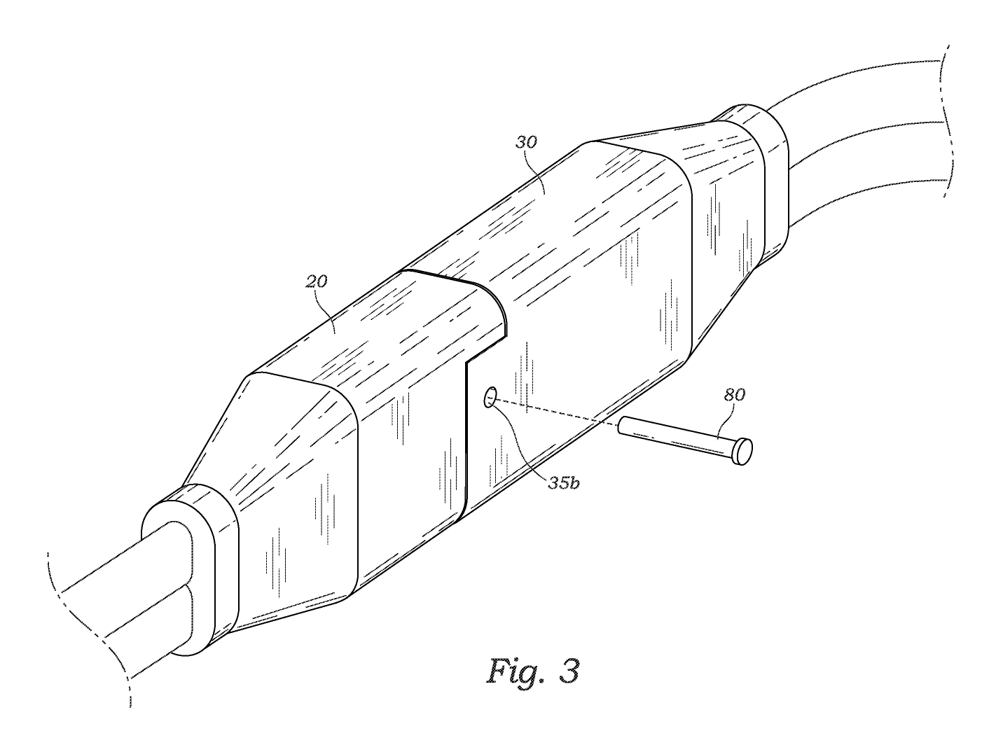

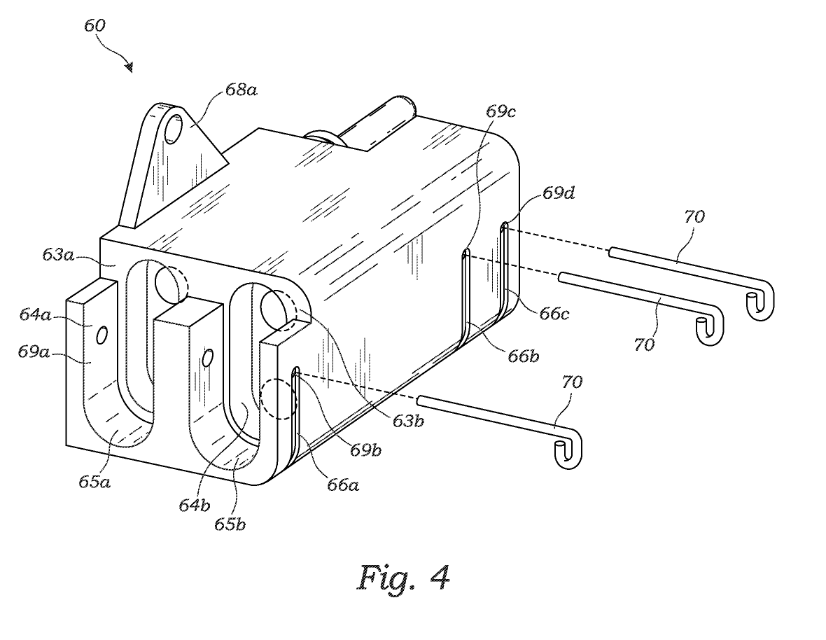

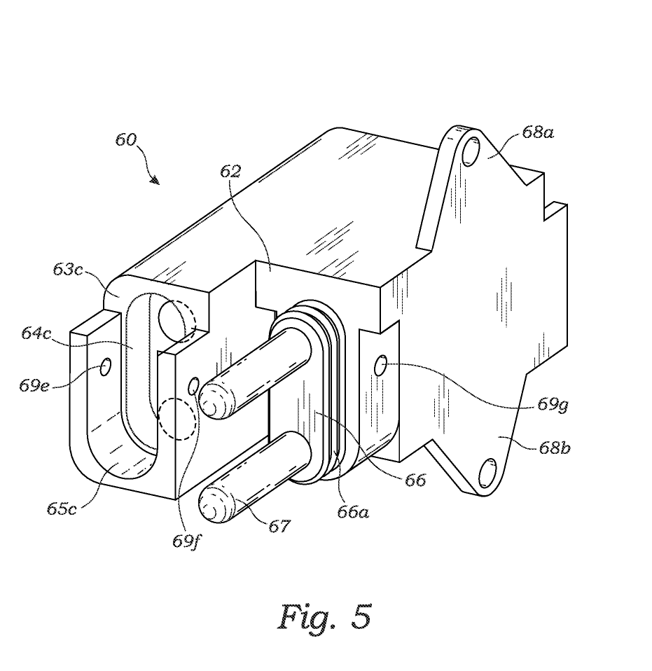

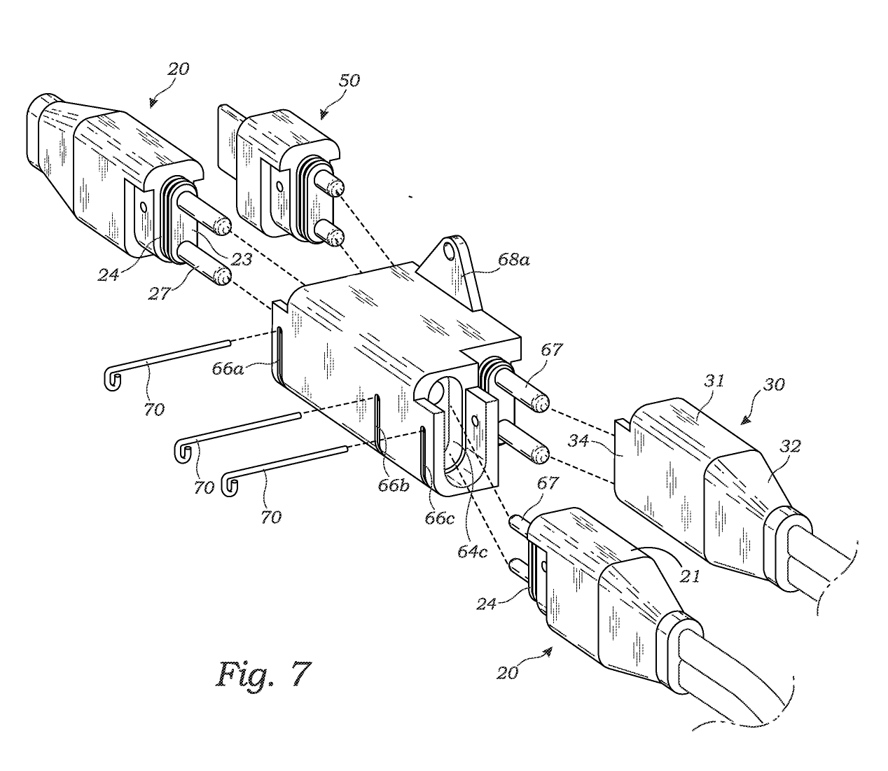

Because the male cable connector 20 has two conductor wiring (positive and negative), in order to assist in the correct mating of the male cable connector 20 to a female cable connector 30 (FIG. 2) or a female block connector of the junction block 60 (FIGS. 4 and 5), the center portion 21 of the male cable connector 20 has a front generally U-shaped cutout or recess 25 being about 0.25 inches in depth to receive a matching portion of the female connector 30 or the female block connector of the junction block 60. The front U-shaped cutout or recess 25 starts at about 0.4 inches from the top (same end having positive conductor) of the center portion 21 of the male cable connector 20. The front U-shaped cutout or recess 25 has an aperture 26 with its center being about halfway between the top and bottom of the male cable connector 20, and about halfway between the front edge of the center portion 21 to the wall of the cutout or recess. The aperture 26 is for inserting a harness lock pin 80 (FIGS. 3 and 7) when the male cable connector 20 is mated with a female cable connector 30 (FIG. 2), or with a female block connector of the junction block 60 (FIGS. 4 and 5), as further described below.

The generally oblong projecting portion 23 of the male cable connector 20 is fitted on the outside with a gasket or seal 24, preferably fabricated in a resilient sealing material, e.g., silicone, to create a seal between the male cable connector 20 and a female cable connector 30 (FIG. 2) or a female block connector 63 of a junction block 60 (FIGS. 4 and 5). The seal surrounds the projecting portion 23 and prevents moisture from entering the connectors when the male cable connector 20 is mated with the female cable connector 30, or with the female block connector 63 of the junction block 60. The gasket 24 has two grooves separating and defining three ridges, and is made of resilient material, allowing it to be freely removed and replaced, if necessary.

Alternatively, sufficient sealing could be accomplished in other ways. For example, the oblong projecting portion 23 could have one or more grooves that encircle it, in which one or more resilient bands of rubberized material (circular in cross-section) could reside. In this way, any gap between the oblong projecting portion 23 of the male cable connector 20 and the passageway 33 of the female cable connector 30 would be sealed, thereby preventing or at least reducing the risk that dust, dirt, moisture or other impurities or reactants would contact the prongs or other electrical components when they are electrified. This reduces corrosion of the wiring components.

To support high current electricity, the male cable connector 20 has at least two precision, electrically conductive connecting prongs 27, preferably made of brass, capable of carrying 0-200 amps of current. Each prong 27 has an end communicating with the oblong projecting portion 23, and a distal end. The ends of the prongs 27 communicating with the male cable connector 20 are crimped (or soldered or both) on the electric cables 90 during manufacturing. The electric cables 90 are preferably fabricated using 6 American Wire Gauge (AWG) standard copper wires. In order to assist in the correct installation of the male cable connector 20 and the molded cables 90 to an electrical source or equipment, the jacket of the cables 90 are marked such that the positive conductor wire will have a jacket with a red color stripe.

During manufacture, the electrical cables 90 are molded to the male cable connector 30. The jacket of the electrical cables 90 is made of the same electrically insulating material as with the male cable connector 20. As such, the male cable connector 20 fuses together with the jacket of the electrical cables 90. At the distal end of the cables 90, two terminal rings 29a/29b are crimped (or soldered) onto the cables. The crimped ends of the terminal rings 29a/29b are wrapped in color coded electrically insulating jacket 28a/28b. Red color is used for the jacket 28a wrapping the ring 29a that terminates the positive conductor wire. Black color is used for the jacket 28b wrapping the ring 29b that terminates the negative conductor wire. The terminal rings 29a/29b are ready for connecting the cables 90 to electric motors and devices.

Referring to FIG. 2, the female connector 30 is molded with a weather resistant and electrically insulating (or electrically non-conducting) material such as hard plastic, preferably polyvinylchloride (PVC) rubber. The female connector 30 has a generally rectangular center portion 31 being about 2 inches from front to back, about 1.4 inches from top to bottom, and about 0.8 inches thick, a rear portion 32 tapering toward the rear, and a generally U-shaped flange 3.4 in the front. The general shape and dimension of the female connector 30 is adapted to fit into and through the wiring channels of truck boxes or trailers.

The U-shaped flange 34 contains bilateral apertures 35a and 35b on opposing sides. The apertures 35a/35b have passages such that a single cylindrical pin with appropriate dimensions can pass through both. The application of the apertures and associated pin is further described below.

Similar to the male cable connector 20, during manufacture, the electrical cables 90 are molded to the female cable connector 30. The jacket of the electrical cables 90 is made of the same electrically insulating material as with the female cable connector 30.

For safety purposes, generally throughout the invention contemplated herein, the male connectors are intended to be connected to hot female connectors. In this way, the exposed prongs of the male connectors are not carrying a charge that could injure a handler and damage equipment. On the other hand, the electrical components of the female connectors are recessed out of the way of inadvertent contact with hands, clothes or equipment. The arrangements described herein, when used, have electrical components well covered at the point where the connections are made, reducing the risk of sparking, shock, injury or property damage during the connection d disconnection operations.

The U-shaped flange 34 on the female connector provides additional shielding against inadvertent contact with hot wires, or ground, or inadvertent sparks at the point of connection. However, the U-shaped flange and corresponding U-shaped space 25 on the male connector could be reversed such that the male connector included a U-shaped flange and the female connector included a U-shaped space. Such as arrangement would continue to provide some of the benefits contemplated herein.

In order o assist in the correct mating of the female cable connector 30 to a male cable connector 20 (FIG. 3) or the male block connector of the junction block 60 (FIGS. 4 and 5), the female cable connector 30 has a front generally U-shaped flange 34 being about 0.4 inches from front to back, and a passageway 33. The passageway 33 receives the front portion 23 of the male cable connector 20 when the male cable connector 20 is mated with the female cable connector 30. The U-shaped flange 34 fits into the front U-shape cutout or recess 25 of a male cable connector 20 when the male cable connector 20 is mated with the female cable connector 30. The female cable connector 30 includes at least two electrically conductive sockets or openings adapted to tit the opposing electrically conductive connecting prongs 27 of a male cable connector 20 or the opposing electrically conductive connecting prongs 67 a male block connector 62 (FIG. 5).

The end of cable 90 opposite of the female cable connector 30 can be either a male cable connector, for example, if needed to be used as an extension between other male and females connections in the system. However, that end could also include a different component. As shown in FIG. 2, the other end contains a trailer male connector 36.

Trailer male connector 36 is molded to cable 90 as described above for male connector 20 and female connector 30. It contains a cylindrical passageway 37 exposing prongs 42. A cap 38 is pivotally hinged to the trailer male connector 36, with spring 39 communicating between the two to bias the cap 38 to a position to cover the passageway 37. When the trailer male connector is in use, the cap 38 will rest against the female connector mated with the trailer male connector 36. However, when there is no mated connection, the cap 38 is held by the spring tightly against the passageway 37 entry, creating a moisture and duct proof seal.

The trailer male connector contains two, bilateral flanges 40 with apertures 41. Screws or bolts (not shown) can pass through the apertures to secure the trailer male connector 36 to the sidewall or other structure in the truck box or trailer. The use of the trailer male connector 36 with other components in a trailer electrical system is described in more detail below.

Referring to FIG. 3, the male cable connector 20 is mated with the female cable connector 30. The harness lock pin 80 is inserted to secure the male cable connector 20 to the female cable connector 30. The harness lock pin 80 goes through aperture 35b (FIGS. 2 and 3) of the female cable connector 30, aperture 26 (FIG. 1) of the male cable connector 20, and aperture 35a (FIG. 2) of the female cable connector 30. As such, when the harness lock pin 80 is in place through apertures 35a, 26, and 35b, it holds male cable connector 20 and female cable connector 30 securely together against pulling forces on the cable.

Referring to FIGS. 4 and 5, the junction block 60 is molded with a weather resistant, electrically insulating (or electrically non-conducting) material such as hard plastic, preferably polyvinylchloride (PVC). The junction block 60 has a generally rectangular center portion 61 configured to fit in the appropriate places in a truck box or trailer. Preferably it is about 3 inches from front to back, about 1.4 inches from top to bottom, and about 1.8 inches thick. The junction block 60 is shown with one male block connector 62 and three female block connectors 63a/63b/63c.

Each female block connectors 63a/63b/63c are constructed to receive male cable connector 20 (FIG. 1). As such, the construction of each of the three female block connectors 63a/63b/63c is generally correlating to the construction of the female connector 30. Each female block connector 63a/63b/63c has a passageway 64a/64b/64c which is generally similar to the passageway 33 of the female connector 30. Each female block connector 63a/63b/63c has a generally U-shaped flange 65a/ 65b/ 65c which is generally similar to the flange 34 of the female connector 30. Each female block connector 63a/63b/63c also has an aperture 69a/69b/69e/69f similar to apertures 35a/ 35b of the female connector 30.

The center portion 61 of the junction block 60 has a cutout for the male block connector 62. The male block connector 62 of the junction block 60 is constructed to fit into the female cable connector 30. As such, the construction of the male block connector 62 is generally similar to the construction of the male cable connector 20. The male block connector 62 has a front oblong portion 66 that is generally are to the front Oblong portion 23 of the male cable connector 20. The front portion 66 is also fitted with on the outside with a seal or gasket 66a. The male block connector 62 also has an aperture to receive a harness lock pin when the male block connector 62 is orated with a female cable connector 30. The construction of prongs 67 of the male block connector 62 is generally similar to the construction of prongs 27 of the male cable connector 20.

In the past, soft rubber was typically used to provide electric insulation and an adequate seal between two electrical connections. However,soft rubber is expensive to use and has other undesirable characteristics. The presently contemplated connections obtain comparable seals with the use of hard plastic, preferable polyvinylchloride, for the connector and block material, but with a resilient seal or gasket of softer material to seal the space between the male connector's oblong projecting portion and the female connector's passageway.

The junction block 60 has two generally triangular support flanges 68a/68b at the top and bottom. The two flanges 68a/68b are flushed against the back all of the junction block 60 and have apertures so that the junction block 60 can be mounted, using screws (not shown) to a truck box trailer wall or other support or platform.

The junction block 60 has three slots 66a/66b/66c on the front wall. Two outside grooves are extended downward from the apertures 69b and 69d on the flanges 65b and 65c of the female block connectors 63b and 63c to the bottom wall of the junction block 60. One inside slot 66b is extended from the inside aperture 69c, which is aligned with the apertures 69g (FIG. 5) on the male block connector 62, to the bottom wall of the junction block 60. A harness lock pin 70 can be inserted into each of the apertures when a male cable connector 20 is mated with the female block connector 63a/63b/63c, or when a female cable connector 30 is mated with the male block connector 62. The harness lock pin 70 has a loop at one end. A portion of the loop of the harness lock pin 70 fits into the slots 66a/66b/66c when the harness lock pin 70 is inserted into one of the three apertures from where the slots extend. The slots are under-cut to provide an interference fit with the loop of the pins. This retains the pin in place and prevents rotation of the pin and inadvertent movement of the pin out of the aperture until the pin is at least partially withdrawn from the slots 66a/66b/66c.

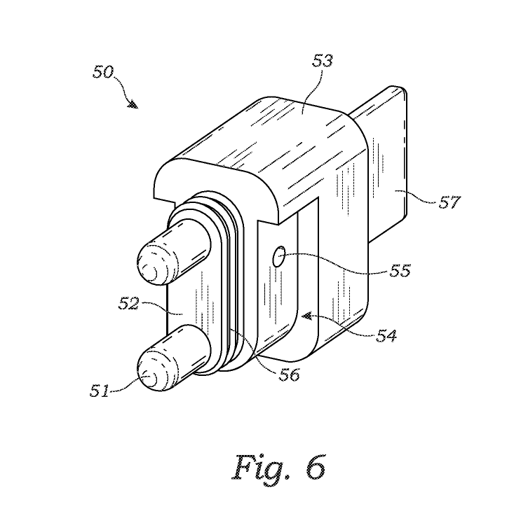

Referring to FIG. 6, a male plug 50, molded with a weather resistant and electrically insulating material, preferably polyvinylchloride (PVC) rubber, is used to plug into a finale block connector 63a/63b/63c when the female block connector 63a/63b/63c is not mated with a male connector 20. As described herein, the junction block additional electrical connections are easily added to accommodate to new electric motors or other devices on the truck box or trailer.

The junction block 60 has three female block connectors, providing for connections to three independent electrical motors or devices. The positive input voltage supplied to one of the two pins of the male block connector 62 communicates electrically (through conductive structures within the junction block) with the corresponding positive output sockets on the female block connectors 63a/63b/63c. Similarly, the ground pin of the male block connector 62 communicates electrically with the corresponding ground socket of the female block connectors 63a/63b/63c.

The junction block may be initially installed with one or two unused female block connections, providing the potential easy wiring connection to retrofit electrical devices that are added later. In order to prevent the female block connectors from being exposed to the harsh ambient environment, a male plug 50 is used. In order to provide an efficient seal, it has a shape that generally matches the male cable connector. In particular, the preferred embodiment has two dummy prongs 51, a generally oblong front portion 52, a center portion 53 with a generally U-shaped cutout 54 for receiving the generally U-shaped flange 65a/ 65b/ 65c of the female block connector 63a/63b/63c, and an aperture 55 for receiving a harness lock pin 70. If needed, the male plug 50 could be used to seal the unused, open end of a female cable connector.

As mentioned above, the U-shaped flange associated with the female cable connectors, and U-shaped space associated with the male cable connectors could be reversed. If such an arrangement was used, the junction block could be similarly modified such that a U-shaped flange would be associated with the male block connector 62 and U-shaped spaces would be associated with the female block connectors 63a/63b/63c. This arrangement still allows (1) for female cable connectors to mate with male cable connectors and male block connectors, and (2) for male cable connectors to mate with female cable connectors and female block, connectors. Such junctions can be secured with the use of a lock pin placed in the aligned apertures in the U-shaped flanges and projecting portions.

As generally contemplated herein, a female plug (not shown) having a similar shape as the female cable connector could be utilized to seal the male block connector. The preferred embodiment of the junction block contemplated herein has only a single male block connector that in most cases would be used from the time of initial installation because it functions to bring power into the junction block. However, in the relatively unusual occasion where the single male block connector is unused or a junction block contains an unused second male block connector, a female plug could be utilized. If needed, the female plug could be used to seal the unused, open end of a female cable connector.

Referring to FIG. 7, the system of connector and multi-port junction block is shown in a preferred embodiment. As described above, the junction block 60 can be mated with up to three male cable connectors 20 and one female cable connector 30 at the same time. When a male cable connector 20 is not used or needed, a male plug 50 can be mated with the female block connectors 63a/63b/63c of the junction block 60 in order to prevent moisture, dust, or other contaminants from entering the junction block 60. Harness lock pins 70 are used to secure male cable connector 20, female cable connector 30, and male plug 50 to the junction block 60. Screws (not shown) are placed through the apertures in flanges 68a/68b to attach the junction block 60 to a trailer wall or other support structure on the trailer.

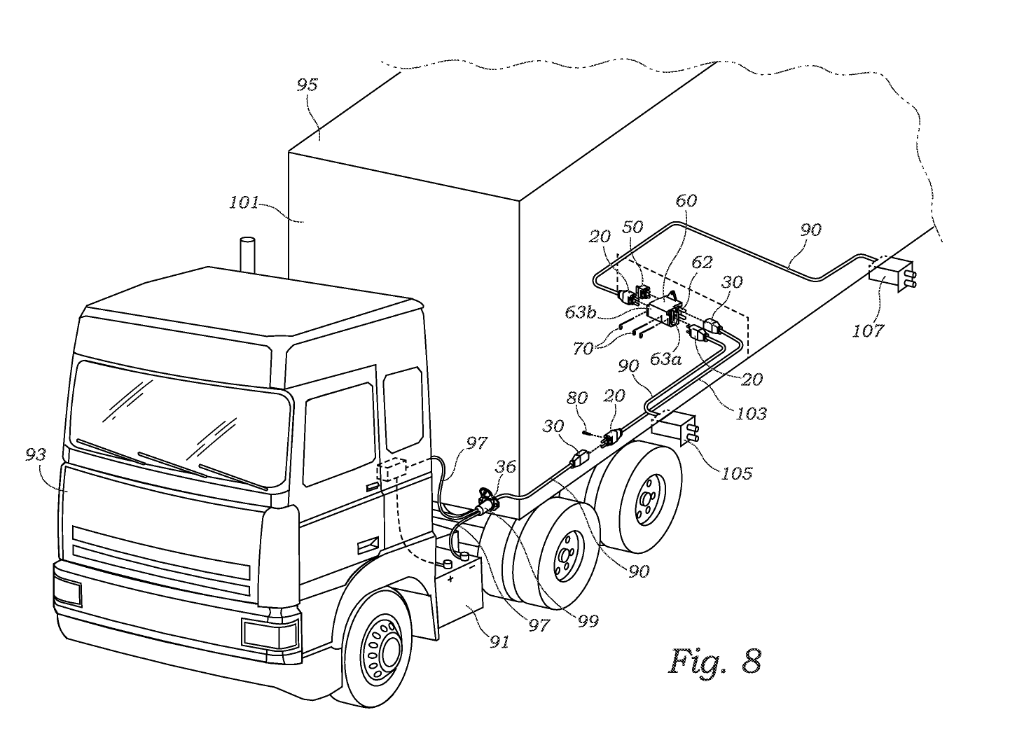

Persons who build, use and work on truck boxes and trailers will appreciate that there are a variety of possible arrangements of the cables, connectors and junction block described above. FIG. 8 shows merely one way in which they could be used together in a truck box or trailer. However, many other ways are contemplated and accomplishable with the information contained in herein.

With respect to the embodiment of FIG. 8, a battery 91 residing in a truck cab 93 provides electricity to run devices on an associated trailer 95. Electrical wires 97 can power from the battery 91 in the cab 93 to the trailer 95. They include an electrical female connector 99 that mates with a trailer male electrical connector 36 mounted on the front wall 101 of the trailer 95. This connection is easily reversible to facilitate swapping of trailers and cabs. When connected, the electrical system on the trailer becomes energized.

The trailer male connector 36 has a cable 90 and female cable connector 30 of the type shown in FIG. 2 on its opposite end. An extension cable 103 brings power to the junction block. It has at one end a male cable connector 20 of the type shown in FIG. 1 and, at the other end a female cable connector 30 of the type shown in FIG. 2. The male end 20 mates with the female end 30 of cable 90 connected to the male trailer connector 36 at the front wall 101 of the trailer 95. The female end 30 mates with junction block 60 at the male block connector 62 of the type shown in FIG. 5. A harness lock pin 70 of the type shown in FIGS. 4 and 7 secures the connection against inadvertent disconnection due to pulling on the wires or plugs. This completes the wiring that brings electricity from the battery 91 to the junction block 60.

The electrical power is then distributed from the junction block 60 to two hopper door motors, a forward hopper door motor 105 and a rearward hopper door motor 107. Forward hopper door motor 105 is connected to a cable 90 by use of terminal rings 29a/29b of the type shown in FIG. 1 (not shown in FIG. 8). The other end of the cable contains a male cable connector 20. The male cable connector 20 is mated with a female block connector 63c in the junction block 60 to create a sealing connection. A harness lock pin 70 of the type shown in FIGS. 4 and 7 secures the male cable connector 20 to the female block connector 63c.

Similarly, the rearward hopper door motor 107 is connected to a cable 90 by use of terminal rings 29a/29b of the type shown in FIG. 1 (not shown in FIG. 8). The other end of the cable contains a male cable connector 20. The male cable connector 20 is mated with a female block connector 30 in the junction block 60 to create a sealing connection. A harness lock pin 70 of the type shower FIGS. 4 and 7 secures the male cable connector 20 to the female block connector 63b.

The two male cable connectors 20, along with a female cable connector 30, are no secured in the two female block connectors 63b and 63c, and one male block connector 62 in the junction block 60. This leaves one unused female block connector 63a in the junction block that is available to be connected and bring power to a later-added electrical device on the trailer. This is easily accomplished by merely connecting the new device to terminal rings 29a/29b at one end of a cable 90 and a male cable connector 20 at the other end. However, until that additional device is added, a protective plug 50 is inserted into the unused female block connector 63a to protect it against the ambient environment and reduce any corrosion that could occur at the metal electrical surfaces.

Multiple junction blocks 60 can be utilized on a single trailer to provide the potential to provide power to five or more motors or other devices. This is accomplished by attaching additional junction blocks 60 to the trailer 95.

The two junction blocks are connected by using an extension cable with a male cable connector 20 on one end and a female cable connector on the other end. The male connector 20 is mated with an unused female block connector, for example 63a in FIG. 8, and the female cable connector 30 is mated with the male block connector 62 of a second junction block (not shown). This brings power to the second junction block and makes an additional three female block connectors available to be connected with and energize three additional motors or devices.

In the foregoing specification, the invention has been described with reference to specific embodiments thereof. It will, however, be evident that various modifications and changes may be made thereto without departing from the broader spirit and scope of the invention. Additionally and obviously, features may be added or subtracted as desired. Accordingly, the invention is not to be restricted except in light of the attached claims and

What is claimed is:

1. A corrosion resistant junction block capable of electrically communicating between a female cable connector from a power source and a plurality of male cable connectors connected to electric devices, the junction block comprising:
at least one male electrical block connector including at least two electrically conductive connecting prongs, each prong having an end communicating with the junction block and a distal end, the ends communicating with the junction block being surrounded by an projecting portion of the block, the projecting portion of the block adapted to mate with the female cable connector;
a plurality of female block connectors each including at least two electrically conductive sockets, the sockets residing inside a passageway adapted to mate with the male cable connector;
wherein the non-metallic portions of the junction block are formed from weather resistant and electrically insulating material.

2. The junction block of claim 1 further comprising a resilient sealing means surrounding the projecting portion.

3. The junction block of claim 1 wherein the projecting portion of the male block connector includes an aperture capable of receiving a lock pin.

4. The junction block of claim 1 wherein the weather resistant and electrically insulating material is hard plastic.

5. The junction block of claim 1 wherein the male block connector defines a U-shaped space.

6. The junction block of claim 1 wherein the female block connector includes a U-shaped flange.

7. The junction block of claim 6 wherein the U-shaped flange includes two opposing apertures capable of receiving a lock pin.

8. The junction block of claim 2 wherein the projecting portion and the passageway is oblong.

9. A corrosion resistant male cable connector comprising:
at least two electrically conductive connecting prongs, each prong having an end communicating with the junction block and a distal end, the ends communicating with the junction block being surrounded by an projecting portion of the block, the projecting portion of the block adapted to mate with a female cable connector; and
wherein said male cable connector defines a U-shaped space, and
wherein the nonmetal portions of the male cable connector are made of a weather resistant and electrically insulating material.

10. The corrosion resistant male cable connector of claim 9 further comprising a resilient sealing means surrounding the projecting portion.

11. The corrosion resistant male cable connector of claim 10 wherein the projecting portion of the male block connector and the passageway of the female connector is oblong.

12. The corrosion resistant male cable connector of claim 9 wherein the projecting portion of the male block connector includes an aperture capable of receiving a lock pin.

13. The corrosion resistant male cable connector of claim 9 wherein the weather resistant material is hard plastic.

14. The corrosion resistant male cable connector of claim 9 wherein the weather resistant material is polyvinylchloride.

15. A corrosion resistant female cable connector comprising:
at least two electrically conductive sockets;
a passageway leading to the conductive sockets;
a U-shaped flange adjacent to the passageway; and
at least one aperture on the U-shaped flange capable of receiving a lock pin;
wherein the non-metal portions of the female cable connector are made of a weather-resistant and electrically non-conducting material.

16. The corrosion resistant female connector of claim 15 wherein the passageway is oblong in cross-section.

17. The corrosion resistant female connector of claim 15 comprising two apertures on opposing sides of the U-shaped flange capable of receiving a single lock pin.

18. The corrosion resistant female cable connector of claim 15, wherein the weather resistant and electrically non-conducting material is hard plastic.

19. The corrosion resistant female cable connector of claim 15, wherein the weather resistant and electrically non-conducting material is polyvinylchloride.

20. A corrosion resistant electrical system for communicating between a power source and multiple electric devices on a truck box or trailer, the system comprising:
a first cable having a first end adapted for connection to the power source and having a female cable connector at the second end;
a junction block including at least one male block connector adapted to reversibly mate with the female cable connector from the power source and at least two female block connectors adapted to reversibly mate with male cable connectors;
a second cable, the second cable having at one end a male cable connector adapted to reversibly mate with the female block connector and at the other end means for electrical attachment to an electrical device.

21. The corrosion resistant electrical system of claim 20, further comprising a third cable, the third cable having at a first end a male cable connector adapted to reversibly mate with a female block connector and at a second end means for electrical attachment to a second electrical device.

22. The corrosion resistant electrical system of claim 20, further comprising a trailer male connector at the front end of the first cable, the trailer male connector adapted for reversible connection to the power source.

23. The corrosion resistant electrical system of claim 20, wherein the female block connector comprises an oblong passageway, and wherein the male cable connectors have an oblong projecting portion surrounded by resilient seal dimensioned to fill the space between the projecting portion of the male block connector and the oblong passageway of the female block connector.

24. The corrosion resistant electrical system of claim 20, wherein the female cable connector comprises an oblong passageway, and wherein the male block connector comprises an oblong projecting portion surrounded by a resilient seal dimensioned to fill the space between the projecting portion of the male block connector and the passageway of the female cable connector.

25. The corrosion resistant electrical system of claim 21, wherein at least one female cable connector further comprises a U-shaped flange.

26. The corrosion resistant electrical system of claim 25, wherein at least one male cable connector has a U-shaped space corresponding to the U-shaped flange.

27. The corrosion resistant electrical system of claim 26, wherein at least one female block connector further comprises a U-shaped flange.

28. The corrosion resistant electrical system of claim 27, wherein the male block connector has a U-shaped space.

29. The corrosion resistant electrical system of claim 25, wherein at least one U-shaped flange contains an aperture.

30. The corrosion resistant electrical system of claim 29, further comprising a lock pin.
